(19) United States
(12) Patent Application Publication
(10) Pub. No.: US 2021/0112440 A1
(43) Pub. Date: Apr. 15, 2021

(54) Distributing UEs for Service with Throughput and Delay Guarantees

(71) Applicant: Parallel Wireless, Inc., Nashua, NH (US)

(72) Inventor: Prashanth Rao, Wilmington, MA (US)

(21) Appl. No.: 17/069,858

(22) Filed: Oct. 13, 2020

Related U.S. Application Data
(60) Provisional application No. 62/913,415, filed on Oct. 10, 2019.

(51) Int. Cl. H04W 28/02; H04W 72/08

(52) U.S. Cl. CPC H04W 28/0268; H04W 72/082; H04W 28/0257

(57) ABSTRACT

A method, system and computer readable medium are described for distributing User Equipments (UEs) for service with guaranteed bitrate. In one embodiment, a method includes receiving, at a self-organizing network (SON) controller, a set of observable data from a sector-carrier; directing, by the SON controller, a sector-carrier to redirect a specific UE to a specified E-UTRA Absolute Radio Frequency Channel Number (EARFCN) by a message to the sector-carrier; estimating, by the SON controller, a level of interference of a sector-carrier; and when an interference level is greater than a predetermined threshold, directing all UEs on the sector-carrier to another sector-carrier controlled by the SON.

### CROSS-REFERENCE TO RELATED APPLICATIONS

This application claims priority under 35 U.S.C. § 119(e) to U.S. Provisional Pat. App. No. 62/913,415, filed Oct. 10, 2019, titled “Distributing UEs for Service with Throughput and Delay Guarantees” which is hereby incorporated by reference in its entirety for all purposes. The present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

The 3^{rd} Generation Partnership Project (3GPP) has standardized 4G and 5G radio access technologies, including methods for user equipments (UEs) to be served by base stations (eNodeBs for 4G, gNodeBs for 5G). Base stations provide carriers to UEs, and often provide multiple carriers in sectors, where a plurality of sectors corresponding to fields of view of the antenna is served by a different carrier.

In a scenario where multiple LTE (or 5G) sector-carriers are deployed to serve a collection of UEs with bitrate and delay guarantees, there is need for a load balancing solution that minimizes the probability that any of the UEs in the collection fail to meet their performance guarantees. Further, it is possible that one or more of the sector-carriers may be subject to interference from adversarial or un-coordinated use of the spectrum. The load balancing algorithm should be able to detect and mitigate the presence of interference by intelligently distributing the affected UEs to other sector-carriers.

### SUMMARY

In one embodiment a method for distributing User Equipments (UEs) for service with guaranteed bitrate, includes receiving, at a self-organizing network (SON) controller, a set of observable data from a sector-carrier; directing, by the SON controller, a sector-carrier to redirect a specific UE to a specified E-UTRA Absolute Radio Frequency Channel Number (EARFCN) by a message to the sector-carrier; estimating, by the SON controller, a level of interference of a sector-carrier; when an interference level is greater than a predetermined threshold, directing all UEs on the sector-carrier to another sector-carrier controlled by the SON.

In another embodiment, a system includes a self-organizing network (SON) controller; a base transceiver station (BTS) in communication with the SON controller; a plurality of sector carriers in communication with the BTS; and at least one user equipment in communication with one of the plurality of sector carriers, wherein the SON receives a set of observable data from a sector-carrier, directs a sector-carrier to redirect a specific UE to a specified E-UTRA Absolute Radio Frequency Channel Number (EARFCN) by a message to the sector-carrier, estimates a level of interference of a sector-carrier, and when an interference level is greater than a predetermined threshold, directing all UEs on the sector-carrier to another sector-carrier controlled by the SON.

In another embodiment, a non-transitory computer-readable medium contains instructions for distributing User Equipments (UEs) which, when executed, cause a system to perform steps comprising: receiving, at a self-organizing network (SON) controller, a set of observable data from a sector-carrier; directing, by the SON controller, a sector-carrier to redirect a specific UE to a specified E-UTRA Absolute Radio Frequency Channel Number (EARFCN) by a message to the sector-carrier; estimating, by the SON controller, a level of interference of a sector-carrier; and when an interference level is greater than a predetermined threshold, directing all UEs on the sector-carrier to another sector-carrier controlled by the SON.

### BRIEF DESCRIPTION OF THE DRAWINGS

FIG. 1 is an architecture diagram, in accordance with some embodiments.

FIG. 2 is a schematic network architecture diagram for various radio access technology core networks.

FIG. 3 is an enhanced eNodeB for performing the methods described herein, in accordance with some embodiments.

FIG. 4 is a coordinating server for providing services and performing methods as described herein, in accordance with some embodiments.

### DETAILED DESCRIPTION

In some embodiments, service to the UEs by the sector carriers is coordinated by one or more Self Organizing Network Controllers (“SON Controller”). The SON Controller may be cloud based software. The SON controller may be based at the base station, at an active antenna, at a cabinet on site of the base station, or connected via a backhaul link. The SON controller provides control inputs to a scheduler, which is typically located at a location with low latency relative to the antennas, for example, at the base station, at an active antenna. In some embodiments the SON controller is known as a near-real time Radio Interface Controller (MC). In some embodiments the scheduler is located at a CU (centralized unit).

The present disclosure involves estimating adversarial/un-controllable interferers in conjunction with the concept of load-balancing. Further, this invention discloses proactive load balancing to be in the best possible situation to handle an interferer. By novel application of SON concepts and eNB stack and signal processing aspects to provide a solution. Uplink Interference detection & estimation with SON controlled load balancing and SON controlled interfrequency handovers. Load Balancing between sector-carriers is a known concept. How and when to do it is not common knowledge. Load balancing in the presence of adversarial and un-controllable interferers in not known. Commercial networks do not encounter adversarial interferers as a matter of normal operation. Hence they may not have solved this problem.

UEs may also have guarantees, determined by the system, nominal or real. The guarantees may include throughput/bitrate, QoS, delay/latency, etc. These guarantees may be network slicing guarantees as specified by the 5G standard, or simply standards for adequate service. However, interference may result in the inability to keep these guarantees without intervention.

2. The SON Controller receives the following set of observable data from the sector-carrier on a regular and on-demand basis.

| | |
|---|---|
| (i) | Aggregate Sector-Carrier Wide Statistics: |
| { | |
| (a) | Short Term filtered Total Resource Blocks Available, |
| (b) | Short Term filtered Total Resource Blocks Used, |
| (c) | Number or Connected UEs, |
| (d) | Per Resource Block List of Short Term filtered RSSI of designated Resource |

Blocks,

| (e) | Short Term RSSI Averaged across all Resource Blocks, |
|---|---|
| } | |
| For every UE connected to the sector-carrier, | |
| (ii) | Per-UE Statistics: |
| { | |
| (a) | UE Identity, ( must be unique across sector-carrier at any given instance) |
| (b) | Power Head Room of the UE (defined in LTE standard}, |
| (c) | Buffer Status Report from the UE per logical channel, |
| (d) | Short term filtered Throughput per LTE radio bearer, |
| (e) | Short Term filtered Total Resource Blocks Allocated (includes re-transmissions), |
| (f) | Short term filtered Signal to Interference Noise Ratio, |
| } | |
| Further, for every UE, on an event trigger basis: | |
| (iii) | Per-UE Statistics: |
| { | |
| | UE state: {Connected, Disconnected}, |
| | If UE state is Connected, upon UE's measurement report, |
| | { |
| i. | Serving Cell RSRP, |
| ii. | List of Intra-frequency Neighbor's {PCI, RSRP}, when available, |
| iii. | List of Inter-frequency Neighbor's {PCI, EARFCN, RSRP} when available |
| | } |
| } | |
| 3. | The SON Controller directs a sector-carrier to redirect a specific UE to a specified |

EARFCN by specifying the following in a message to the sector-carrier:

| Load Balancing Redirect Message: | |
|---|---|
| { | |
| (a) | Unique UEId, |
| (b) | Target EARFCN |
| } | |

4. The SON Controller estimates the severity of interference on the uplink of a sector-carrier as follows:

When any of the following interference events occur, a quantized measure of interference is computed from among the following values:

Interference Levels: {InterferenceLevel1, InterferenceLevel2, . . . InterferenceLevelN}

(a) If more than L number of RSSI values reported in observable (2)(d) is greater than a configured value, ABS_INTERFERNCE_THRESHOLD.

When this event occurs, the number of observables in (2)(d) greater than ABS_INTERFERNCE_THRESHOLD are averaged and mapped to an Interference Level

(b) If the short term average of the ratio of the sector-carrier's unused RBs to Total RBs drops below a Interference Mitigation Usage Threshold.

(c) If the short term average of the UE's spectral efficiency decreases from K immediately previous measurement intervals while its serving cell RSRP has not substantially deteriorated in the same period of time.

(d) The Power Head Room reported by the UE falls below a certain threshold while maintaining its desired throughput.

When this event occurs, said ratio is mapped to an Interference Level.

5. When SON Controller declares an Interference Level>INTERFERENCE_REDIRECT_THRESHOLD, all the UEs on that sector-carrier are redirected to another sector-carrier controlled by the SON Controller and marks the sector-carrier is made unusable.

Optionally, the SON Controller may determine the best target of such redirection for each, using as input the reported inter-frequency neighbors of (2)(iii)(iii)

Once the sector-carrier is marked as unusable, the SON Controller monitors the Interference Level of the sector-carrier continually. Once, the Interference Level falls below RENABLE_THRESHOLD, the sector-carrier is made available for use by UEs.

6. Once the sector-carrier is marked as unusable, the SON Controller monitors the Interference Level of the sector-carrier continually. Once, the Interference Level falls below RENABLE_THRESHOLD, the sector-carrier is made available for use by UEs.

7. Load Balancing at Admission:

a. A UE chooses a sector-carrier based on its heuristics.

b. Once connected to a sector-carrier, the SON Controller redirects the UE to a sector-carrier that has the radio resource utilization amongst the candidate sector-carriers for the UE.

Optionally, the SON Controller may determine the best target of such redirection for each, using as input the reported inter-frequency neighbors of (2)(iii)(iii).

8. UE Performance Based Load Balancing:

When any of the conditions listed below are true, the SON Controller redirects the UE to a sector-carrier that has the least Load.

a. Spectral efficiency of UE falls below a certain threshold.

b. Throughput and/or packet delay of the UE falls below a certain threshold and there exists a candidate sector-carrier with sufficient resources to serve the UE in a manner that the UE achieves its desired throughput or packet delay performance.

c. The Power Head Room reported by the UE falls below a certain threshold while maintaining its desired Throughput.

Optionally, the SON Controller may determine the best target of such redirection from within a sub-set of candidate sector-carriers wherein the sub-set is created using as input the reported inter-frequency neighbors of (2)(iii)(iii).

Responding to Catastrophic Interference

In some scenarios, the uplink of the sector-carrier may be subject to such a catastrophic level of interference to the extent that the data transmitted by some of the UEs are not received correctly at the sector-carrier's receiver. When data transmitted by the UE are not correctly received at the receiver for a sustained period of time, the sector-carrier informs SON that the UE suffered Radio Link Failure. If the SON Controller determines that a plurality of UEs suffer Radio Link Failure in a short period to time, the SON Controller determines that the sector-carrier is unusable due to interference and take the sector-carrier out of service.

Once the sector-carrier is marked as unusable, the SON Controller monitors the Interference Level of the sector-carrier continually. When the Interference Level falls below RENABLE_THRESHOLD, the SON Controller directs the sector-carrier to make its resources available for use by UEs.

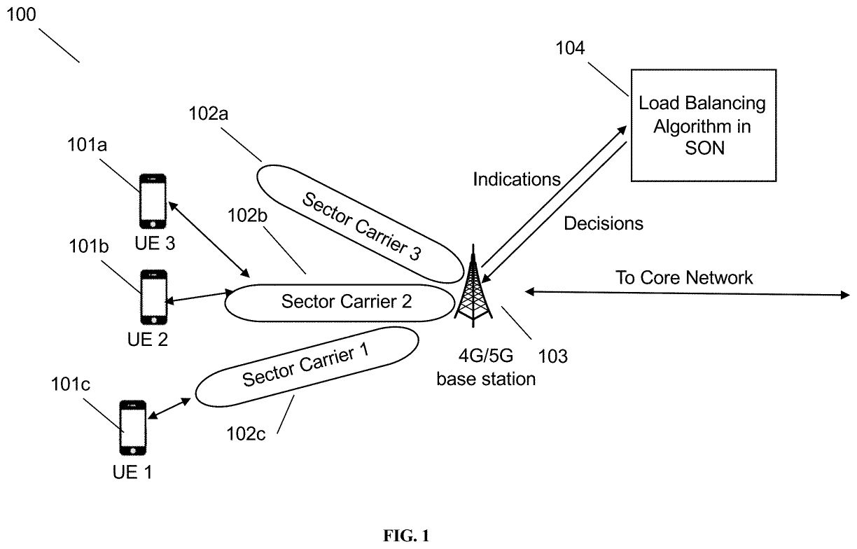

In FIG. 1, an architecture diagram shows a system 100 includes a self-organizing network (SON) 104 controller; a base transceiver station (BTS) 103 in communication with the SON controller; a plurality of sector carriers 102a, 102b and 102c in communication with the BTS; and at least one user equipment 101a, 101b, 101c in communication with one of the plurality of sector carriers, The SON 104 receives a set of observable data(indications) from a sector-carrier, directs a sector-carrier to redirect a specific UE to a specified E-UTRA Absolute Radio Frequency Channel Number (EARFCN) by a message (decisions) to the sector-carrier, estimates a level of interference of a sector-carrier, and when an interference level is greater than a predetermined threshold, directing all UEs on the sector-carrier to another sector-carrier controlled by the SON.

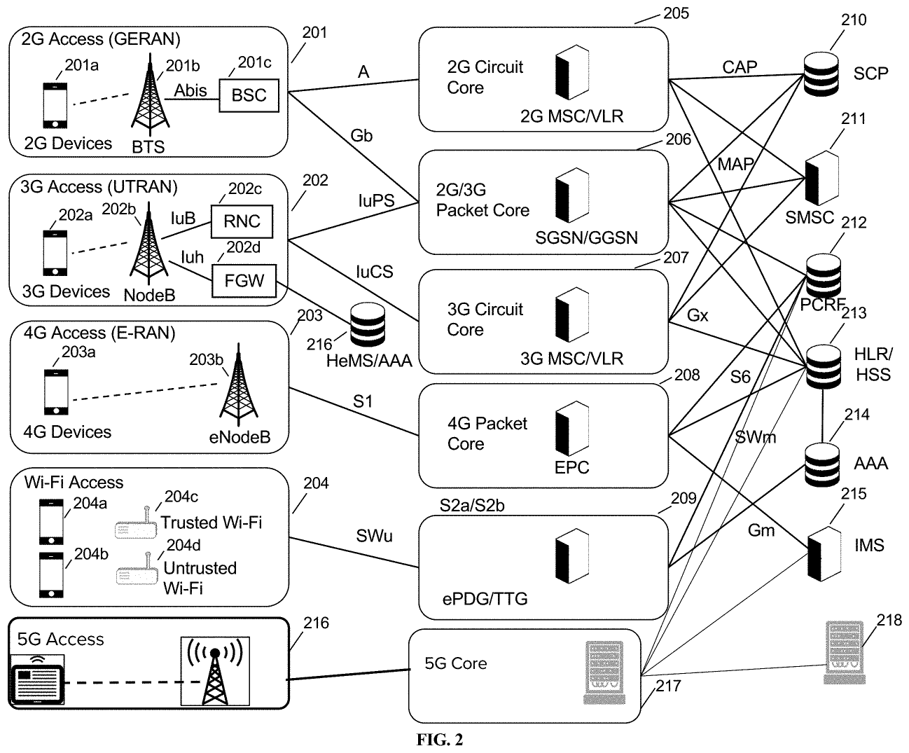

FIG. 2 is a schematic network architecture diagram for 3G and other-G prior art networks. The diagram shows a plurality of “Gs,” including 2G, 3G, 4G, 5G and Wi-Fi. 2G is represented by GERAN 101, which includes a 2G device 201a, BTS 201b, and BSC 201c. 3G is represented by UTRAN 202, which includes a 3G UE 202a, nodeB 202b, RNC 202c, and femto gateway (FGW, which in 3GPP namespace is also known as a Home nodeB Gateway or HNBGW) 202d. 4G is represented by EUTRAN or E-RAN 203, which includes an LTE UE 203a and LTE eNodeB 203b. Wi-Fi is represented by Wi-Fi access network 204, which includes a trusted Wi-Fi access point 204c and an untrusted Wi-Fi access point 204d. The Wi-Fi devices 204a and 204b may access either AP 204c or 204d. In the current network architecture, each “G” has a core network. 2G circuit core network 205 includes a 2G MSC/VLR; 2G/3G packet core network 206 includes an SGSN/GGSN (for EDGE or UMTS packet traffic); 3G circuit core 207 includes a 3G MSC/VLR; 4G circuit core 208 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 230, the SMSC 231, PCRF 232, HLR/HSS 233, Authentication, Authorization, and Accounting server (AAA) 234, and IP Multimedia Subsystem (IMS) 235. An HeMS/AAA 236 is present in some cases for use by the 3G UTRAN. The diagram is used to indicate schematically the basic functions of each network as known to one of skill in the art, and is not intended to be exhaustive. For example, 2G core 217 is shown using a single interface to 2G access 216, although in some cases 2G access can be supported using dual connectivity or via a non-standalone deployment architecture.

Noteworthy is that the RANs 201, 202, 203, 204 and 236 rely on specialized core networks 205, 206, 207, 208, 209, 237 but share essential management databases 230, 231, 232, 233, 234, 235, 238. More specifically, for the 2G GERAN, a BSC 201c is required for Abis compatibility with BTS 201b, while for the 3G UTRAN, an RNC 202c is required for Iub compatibility and an FGW 202d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 2G equipment. 2G networks are digital cellular networks, in which the service area covered by providers is divided into a collection of small geographical areas called cells. Analog signals representing sounds and images are digitized in the phone, converted by an analog to digital converter and transmitted as a stream of bits. All the 2G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

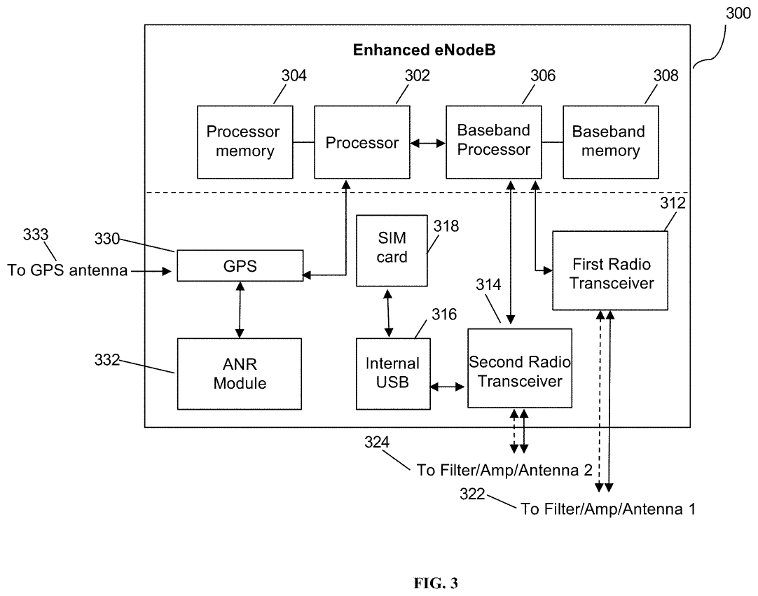

FIG. 3 is an enhanced eNodeB for performing the methods described herein, in accordance with some embodiments. eNodeB 500 may include processor 302, processor memory 304 in communication with the processor, baseband processor 306, and baseband processor memory 308 in communication with the baseband processor. Mesh network node 300 may also include first radio transceiver 312 and second radio transceiver 314, internal universal serial bus (USB) port 316, and subscriber information module card (SIM card) 318 coupled to USB port 316. In some embodiments, the second radio transceiver 314 itself may be coupled to USB port 316, and communications from the baseband processor may be passed through USB port 316. The second radio transceiver may be used for wirelessly backhauling eNodeB 300.

Processor 302 and baseband processor 306 are in communication with one another. Processor 302 may perform routing functions, and may determine if/when a switch in network configuration is needed. Baseband processor 306 may generate and receive radio signals for both radio transceivers 312 and 314, based on instructions from processor 302. In some embodiments, processors 302 and 306 may be on the same physical logic board. In other embodiments, they may be on separate logic boards.

Processor 302 may identify the appropriate network configuration, and may perform routing of packets from one network interface to another accordingly. Processor 302 may use memory 304, in particular to store a routing table to be used for routing packets. Baseband processor 306 may perform operations to generate the radio frequency signals for transmission or retransmission by both transceivers 310 and 312. Baseband processor 306 may also perform operations to decode signals received by transceivers 312 and 314. Baseband processor 306 may use memory 308 to perform these tasks.

The first radio transceiver 312 may be a radio transceiver capable of providing LTE eNodeB functionality, and may be capable of higher power and multi-channel OFDMA. The second radio transceiver 314 may be a radio transceiver capable of providing LTE UE functionality. Both transceivers 312 and 314 may be capable of receiving and transmitting on one or more LTE bands. In some embodiments, either or both of transceivers 312 and 314 may be capable of providing both LTE eNodeB and LTE UE functionality. Transceiver 312 may be coupled to processor 302 via a Peripheral Component Interconnect-Express (PCI-E) bus, and/or via a daughtercard. As transceiver 314 is for providing LTE UE functionality, in effect emulating a user equipment, it may be connected via the same or different PCI-E bus, or by a USB bus, and may also be coupled to SIM card 318. First transceiver 312 may be coupled to first radio frequency (RF) chain (filter, amplifier, antenna) 322, and second transceiver 314 may be coupled to second RF chain (filter, amplifier, antenna) 324.

SIM card 318 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 300 is not an ordinary UE but instead is a special UE for providing backhaul to device 300.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 312 and 314, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 302 for reconfiguration.

A GPS module 330 may also be included, and may be in communication with a GPS antenna 332 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 332 may also be present and may run on processor 302 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

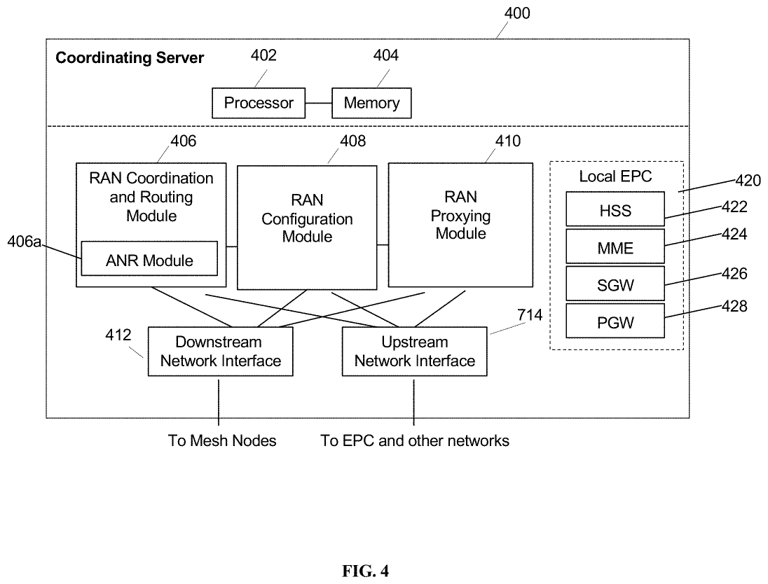

FIG. 4 is a coordinating server for providing services and performing methods as described herein, in accordance with some embodiments. Coordinating server 400 includes processor 402 and memory 404, which are configured to provide the functions described herein. Also present are radio access network coordination/routing (RAN Coordination and routing) module 406, including ANR module 406a, RAN configuration module 408, and RAN proxying module 410. The ANR module 406a may perform the ANR tracking, PCI disambiguation, ECGI requesting, and GPS coalescing and tracking as described herein, in coordination with RAN coordination module 406 (e.g., for requesting ECGIs, etc.). In some embodiments, coordinating server 400 may coordinate multiple RANs using coordination module 406. In some embodiments, coordination server may also provide proxying, routing virtualization and RAN virtualization, via modules 410 and 408. In some embodiments, a downstream network interface 412 is provided for interfacing with the RANs, which may be a radio interface (e.g., LTE), and an upstream network interface 414 is provided for interfacing with the core network, which may be either a radio interface (e.g., LTE) or a wired interface (e.g., Ethernet).

Coordinator 400 includes local evolved packet core (EPC) module 420, for authenticating users, storing and caching priority profile information, and performing other EPC-dependent functions when no backhaul link is available. Local EPC 420 may include local HSS 422, local MME 424, local SGW 426, and local PGW 428, as well as other modules. Local EPC 420 may incorporate these modules as software modules, processes, or containers. Local EPC 420 may alternatively incorporate these modules as a small number of monolithic software processes. Modules 406, 408, 410 and local EPC 420 may each run on processor 402 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB, including specifically 5G, as the 5G technology significantly overlaps with 4G. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for distributing User Equipments (UEs) for service with guaranteed bitrate, the method comprising:
receiving, at a self-organizing network (SON) controller, a set of observable data from a sector-carrier;
directing, by the SON controller, a sector-carrier to redirect a specific UE to a specified E-UTRA Absolute Radio Frequency Channel Number (EARFCN) by a message to the sector-carrier;
estimating, by the SON controller, a level of interference of a sector-carrier;
when an interference level is greater than a predetermined threshold, directing all UEs on the sector-carrier to another sector-carrier controlled by the SON.

2. The method of claim 1 wherein the set of observable data includes aggregate sector-carrier wide statistics.

3. The method of claim 1 wherein the set of observable data includes per-UE statistics for every UE connected to the sector-carrier.

4. The method of claim 1 wherein the set of observable data includes per-UE statistics for every UE on an event trigger basis.

5. The method of claim 1 wherein the set of observable data is received on a regular basis.

6. The method of claim 1 wherein the set of observable data is received on an on-demand basis.

7. A system comprising:
a self-organizing network (SON) controller;
a base transceiver station (BTS) in communication with the SON controller;
a plurality of sector carriers in communication with the BTS; and
at least one user equipment in communication with one of the plurality of sector carriers,
wherein the SON receives a set of observable data from a sector-carrier, directs a sector-carrier to redirect a specific UE to a specified E-UTRA Absolute Radio Frequency Channel Number (EARFCN) by a message to the sector-carrier, estimates a level of interference of a sector-carrier, and when an interference level is greater than a predetermined threshold, directing all UEs on the sector-carrier to another sector-carrier controlled by the SON.

8. The system of claim 7 wherein the set of observable data includes aggregate sector-carrier wide statistics.

9. The system of claim 7 wherein the set of observable data includes per-UE statistics for every UE connected to the sector-carrier.

10. The system of claim 7 wherein the set of observable data includes per-UE statistics for every UE on an event trigger basis.

11. The system of claim 7 wherein the set of observable data is received on a regular basis.

12. The system of claim 7 wherein the set of observable data is received on an on-demand basis.

13. A non-transitory computer-readable medium containing instructions for distributing User Equipments (UEs) which, when executed, cause a system to perform steps comprising:
receiving, at a self-organizing network (SON) controller, a set of observable data from a sector-carrier;
directing, by the SON controller, a sector-carrier to redirect a specific UE to a specified E-UTRA Absolute Radio Frequency Channel Number (EARFCN) by a message to the sector-carrier;
estimating, by the SON controller, a level of interference of a sector-carrier; and
when an interference level is greater than a predetermined threshold, directing all UEs on the sector-carrier to another sector-carrier controlled by the SON.

14. The method of claim 13 further comprising instructions wherein the set of observable data includes aggregate sector-carrier wide statistics.

15. The method of claim 13 further comprising instructions wherein the set of observable data includes per-UE statistics for every UE connected to the sector-carrier.

16. The method of claim 13 further comprising instructions wherein the set of observable data includes per-UE statistics for every UE on an event trigger basis.

17. The method of claim 13 further comprising instructions wherein the set of observable data is received on a regular basis.

18. The method of claim 13 further comprising instructions wherein the set of observable data is received on an on-demand basis.
